(19) United States
(12) Patent Application Publication
(10) Pub. No.: US 2026/0277164 A1
(43) Pub. Date: Sep. 17, 2026

(54) METHOD OF MANUFACTURING WHEEL, PLATE-SHAPED MEMBER, WHEEL, AND TIMEPIECE

(71) Applicant: SEIKO EPSON CORPORATION, Tokyo (JP)

(72) Inventors: Takeo FUNAKAWA, CHINO-SHI (JP); Eiichi NAGASAKA, MINOWA-MACHI (JP)

(21) Appl. No.: 19/563,914

(22) Filed: Mar. 11, 2026

(30) Foreign Application Priority Data
Mar. 13, 2025 (JP) 2025-040329

(51) Int. Cl. G04D 3/00; G04B 13/02

(52) U.S. Cl. CPC G04D 3/0082; G04B 13/027; G04D 3/002; G04D 3/0069

(57) ABSTRACT

A method of manufacturing a wheel including a first step of performing etching on a plate-shaped member made of a brittle material to form a wheel including a plurality of teeth, at least one tooth of which is a coupling tooth having a recess opened radially outward at a leading end, a frame portion disposed outside the wheel, and a coupling portion coupling the frame portion to an inner surface of the recess, and a second step of cutting the coupling portion and the wheel.

### CROSS-REFERENCE TO RELATED APPLICATIONS

The present application is based on, and claims priority from JP Application Serial Number 2025-040329, filed Mar. 13, 2025, the disclosure of which is hereby incorporated by reference herein in its entirety.

### BACKGROUND OF THE INVENTION

### 1. Technical Field

The present disclosure relates to a method of manufacturing a wheel, a plate-shaped member, a wheel, and a timepiece.

### 2. Related Art

JP-A-2025-002811 describes a method of manufacturing a wheel for a timepiece using a silicon wafer that is a brittle material. In this manufacturing method, etching is performed on a silicon wafer to form a wheel, a frame portion disposed outside the wheel, and a coupling portion coupling the wheel to the frame portion. In addition, when the wheel and the coupling portion are cut, the wheel is taken out.

In JP-A-2025-002811, in order to couple the wheel to a frame of the silicon wafer even when an interval between teeth of the wheel is small, the coupling portion coupling the wheel to the frame is coupled to a leading end portion of a corresponding one of the teeth.

In JP-A-2025-002811, however, since the coupling portion is coupled to the leading end of the tooth of the wheel, a broken surface from which the coupling portion has been removed may come into contact with a tooth surface of a mating wheel, and appropriate transmission of a motion may be impossible.

### SUMMARY OF THE INVENTION

A method of manufacturing a wheel includes a first step of performing etching on a plate-shaped member made of a brittle material to form a wheel including a plurality of teeth including a coupling tooth having a recess opened radially outward at a leading end, a frame portion disposed outside the wheel, and a coupling portion coupling the frame portion to an inner surface of the recess, and a second step of cutting the coupling portion and the wheel.

A plate-shaped member is a plate-shaped member made of a brittle material, and including a wheel including a plurality of teeth including a coupling tooth having a recess opened radially outward at a leading end, a frame portion disposed outside the wheel, and a coupling portion coupling the frame portion to an inner surface of the recess.

A wheel is a wheel generated by being cut from a plate-shaped member made of a brittle material and including a plurality of teeth, and the plurality of teeth includes at least one tooth that is a coupling tooth having a recess opened outward radially at a leading end and having a cut surface formed when being cut from the plate-shaped member.

A timepiece includes the above-described wheel.

### BRIEF DESCRIPTION OF DRAWINGS

FIG. 1 is a plan view of a mechanical timepiece.

FIG. 2 is a plan view of a movement of the mechanical timepiece viewed from a front side.

FIG. 3 is a plan view illustrating a configuration of a third wheel and pinion.

FIG. 4 is an enlarged plan view illustrating teeth of the third wheel and pinion.

FIG. 5 is a plan view of a silicon wafer after being etched.

FIG. 6 is an enlarged plan view in which one wheel included in the silicon wafer is enlarged.

FIG. 7 is an enlarged plan view illustrating a coupling portion.

FIG. 8 is an enlarged plan view illustrating the wheel from which the coupling portion is cut.

FIG. 9 is a flowchart illustrating a method of manufacturing a wheel.

FIG. 10 is a process sectional view for explaining the method of manufacturing the wheel.

FIG. 11 is a process sectional view for explaining the method of manufacturing the wheel.

FIG. 12 is a process sectional view for explaining the method of manufacturing the wheel.

FIG. 13 is a process sectional view for explaining the method of manufacturing the wheel.

FIG. 14 is a process sectional view for explaining the method of manufacturing the wheel.

FIG. 15 is a process sectional view for explaining the method of manufacturing the wheel.

FIG. 16 is a process sectional view for explaining the method of manufacturing the wheel.

FIG. 17 is a process sectional view for explaining the method of manufacturing the wheel.

FIG. 18 is a process sectional view for explaining the method of manufacturing the wheel.

FIG. 19 is a flowchart illustrating a method of manufacturing a mechanical timepiece.

FIG. 20 is an enlarged plan view illustrating a main portion of a wheel according to a modification.

### DETAILED DESCRIPTION OF THE INVENTION

Hereinafter, a timepiece, a wheel, and manufacturing methods thereof according to the present embodiment will be described with reference to the drawings.

In each of the following drawings, in order to make each layer or each member have a recognizable size, each layer or each member may be illustrated on a scale different from an actual scale.

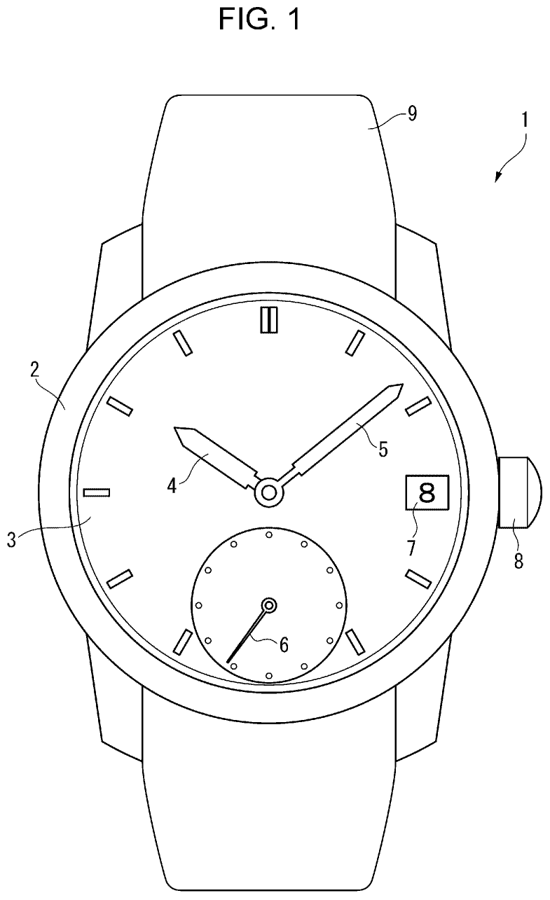

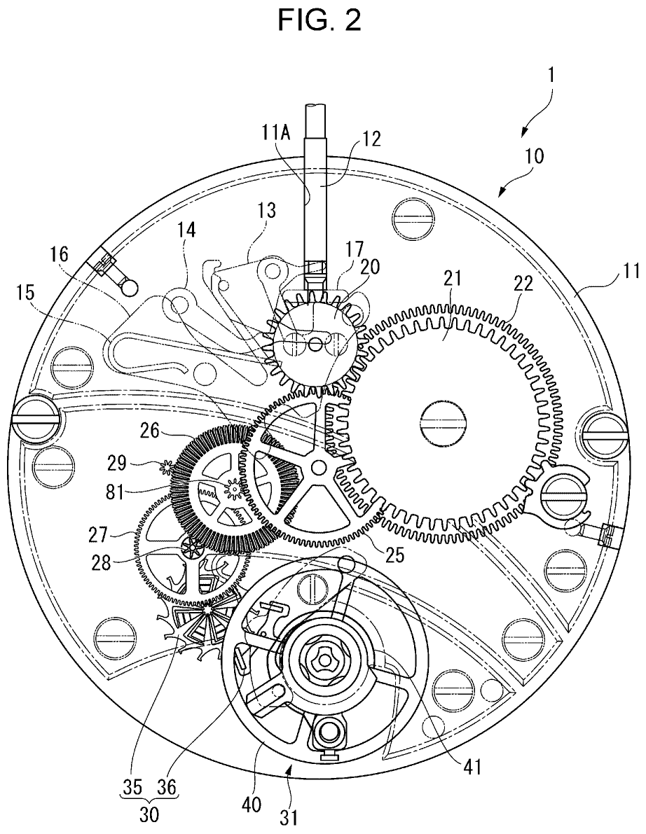

FIG. 1 is a plan view illustrating a mechanical timepiece 1, and FIG. 2 is a plan view illustrating a movement 10 of the mechanical timepiece 1. In the present embodiment, in the mechanical timepiece 1, a rear side is a side on which a cover glass is disposed, and a front side is a side on which a case back is disposed. Therefore, FIG. 1 is a plan view of the mechanical timepiece 1 viewed from the cover glass side, and a forward side of the paper surface of FIG. 1 is a rear side, and a rearward side of the paper surface is a front side. FIG. 2 is a plan view of the movement 10 viewed from the case back side, and a forward side of the paper surface of FIG. 2 is a front side, and a rearward side of the paper surface is a rear side.

As illustrated in FIG. 1, the mechanical timepiece 1 includes a casing 2 and a strap 9. A dial 3, an hour hand 4, a minute hand 5, a small seconds hand 6, a date indicator 7, and a movement 10 illustrated in FIG. 2 are accommodated in the casing 2. A crown 8 is provided on a side surface of the casing 2. The mechanical timepiece 1 is an example of a timepiece.

As illustrated in FIG. 2, the movement 10 includes a main plate 11. The main plate 11 is a plate member for supporting and positioning each component. The dial 3 is disposed on the rear side of the main plate 11. A train wheel including a plurality of wheels is disposed on each of the front side and the rear side of the main plate 11. The train wheel disposed on the front side of the main plate 11, that is, the case back side is also referred to as a front train wheel, and the train wheel disposed on the rear side of the main plate 11, that is, the dial 3 side is also referred to as a rear train wheel.

In the main plate 11, in a direction parallel to the main plate 11 and extending toward a center from an outer edge, a winding stem guide hole 11A that guides a shaft-shaped winding stem 12 is formed. In addition, the winding stem 12 is incorporated so as to be able to move in an axial direction and rotate around the axis with respect to the winding stem guide hole 11A. The crown 8 is attached to a leading end of the winding stem 12. A setting lever 13, a yoke 14, a yoke spring 15, and a setting lever jumper 16 are disposed near the winding stem 12. The setting lever 13, the yoke 14, the yoke spring 15, and the setting lever jumper 16 constitute a switching mechanism that switches a transmission destination of a rotational force of the winding stem 12.

The winding stem 12 is inserted into a winding pinion 17 rotatable coaxially with the winding stem 12. In addition, a clutch wheel (not illustrated) that is rotated together with the winding stem 12 is disposed in the winding stem 12. The clutch wheel is rotatable coaxially with the winding stem 12 and is also movable in the axial direction of the winding stem 12 by the switching mechanism. When the winding stem 12 changes its position in the axial direction, the switching mechanism switches between a state in which the clutch wheel and the winding pinion 17 are meshed and a state in which they are not meshed. In addition, a crown wheel 20 that meshes with the winding pinion 17, a ratchet wheel 21 that meshes with the crown wheel 20, and a barrel complete 22 that accommodates a mainspring are rotatably installed in the main plate 11.

When the winding stem 12 moves in the axial direction and is disposed at a first winding stem position nearest a center of the movement 10, the clutch wheel meshes with the winding pinion 17. When an operator operates the crown 8 to rotate the winding stem 12 in this state, the winding pinion 17 is rotated together with the clutch wheel. Then, when the winding pinion 17 is rotated, the crown wheel 20 is rotated. Then, when the crown wheel 20 is rotated, the ratchet wheel 21 is rotated. Furthermore, when the ratchet wheel 21 is rotated, the mainspring accommodated in the barrel complete 22 is wound up. The mainspring is a power source for driving the movement 10. When the winding stem 12 is disposed at a position further on an outer side than is the first winding stem position, meshing of the clutch wheel and the winding pinion 17 is released, and the clutch wheel meshes with a setting wheel (not illustrated) for performing time adjustment, or the like.

A center wheel and pinion 25, a third wheel and pinion 26 and a fourth wheel and pinion 27 are rotatably disposed on the main plate 11. Each of the center wheel and pinion 25, the third wheel and pinion 26 and the fourth wheel and pinion 27 includes a wheel and a pinion that integrally rotate. The above-described front train wheel is composed of the barrel complete 22, the center wheel and pinion 25, the third wheel and pinion 26 and the fourth wheel and pinion 27. The front train wheel has a function of transmitting a rotational force of the barrel complete 22. In addition, an escapement mechanism 30 and a speed control mechanism 31 are disposed on the main plate 11 on the front side of the movement 10. The escapement mechanism 30 and the speed control mechanism 31 adjust a rotational speed of the front train wheel.

The barrel complete 22 meshes with a pinion (not illustrated) of the center wheel and pinion 25. A cannon pinion (not illustrated) is attached to the center wheel and pinion 25, and the minute hand 5 is attached to the cannon pinion. In addition, the cannon pinion meshes with a minute wheel of the rear train wheel (not illustrated), and the minute wheel meshes with an hour wheel of the rear train wheel (not illustrated). The hour hand 4 is attached to the hour wheel.

A pinion 81 of the third wheel and pinion 26 meshes with a wheel of the center wheel and pinion 25. The third wheel and pinion 26 meshes with a pinion 28 of the fourth wheel and pinion 27 and a seconds wheel 29 for the small seconds hand 6.

The escapement mechanism 30 is a mechanism that controls the rotation of the front train wheel. The escapement mechanism 30 includes an escape wheel and pinion 35 and a pallet fork 36. The escape wheel and pinion 35 has a pinion that meshes with a wheel of the fourth wheel and pinion 27, and rotates by receiving torque of the fourth wheel and pinion 27. The pallet fork 36 rotates the escape wheel and pinion 35 regularly according to the operation of the speed control mechanism 31. The speed control mechanism 31 includes a balance with hairspring 40, a hairspring 41, and the like, and adjusts the rotational speed of the escape wheel and pinion 35 by swinging the balance with hairspring 40 at a constant cycle so as to adjust the rotational speed of the front train wheel that meshes with the escape wheel and pinion 35.

Next, among the above-described various components, the third wheel and pinion 26 will be described in detail.

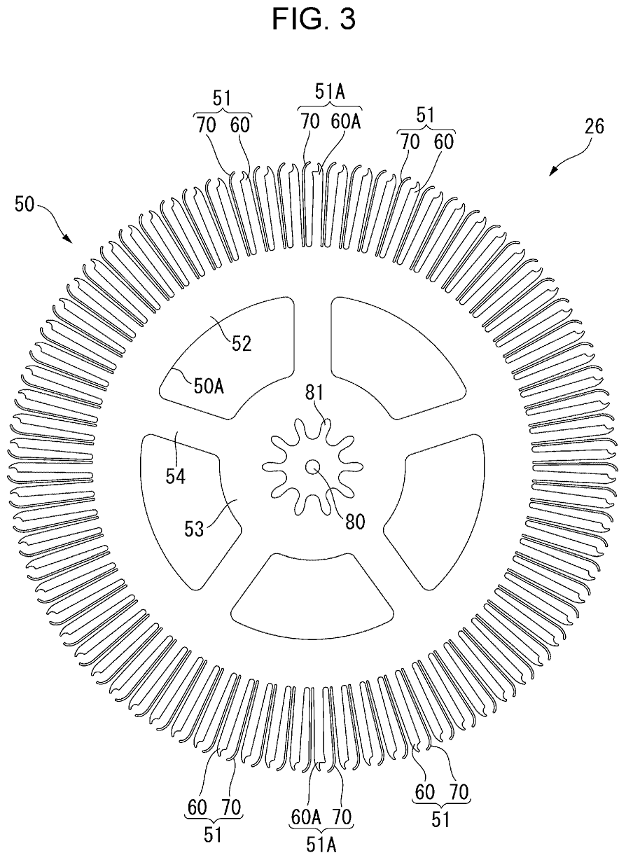

FIG. 3 is a plan view illustrating a configuration of the third wheel and pinion 26.

As illustrated in FIG. 3, the third wheel and pinion 26 includes a wheel 50 and a shaft portion 80 serving as a rotary shaft of the wheel 50. The wheel 50 includes an annular rim portion 52 having a plurality of teeth 51 on an outer peripheral surface, a holding portion 53 through which the shaft portion 80 is inserted, and a plurality of coupling portions 54 that extends radially from the holding portion 53 and couples the rim portion 52 to the holding portion 53. In the wheel 50, opening portions 50A each surrounded by the rim portion 52, the holding portion 53, and two adjacent coupling portions 54 are formed in the wheel 50. The wheel 50 meshes with the pinion 28 included in the fourth wheel and pinion 27, and the seconds wheel 29.

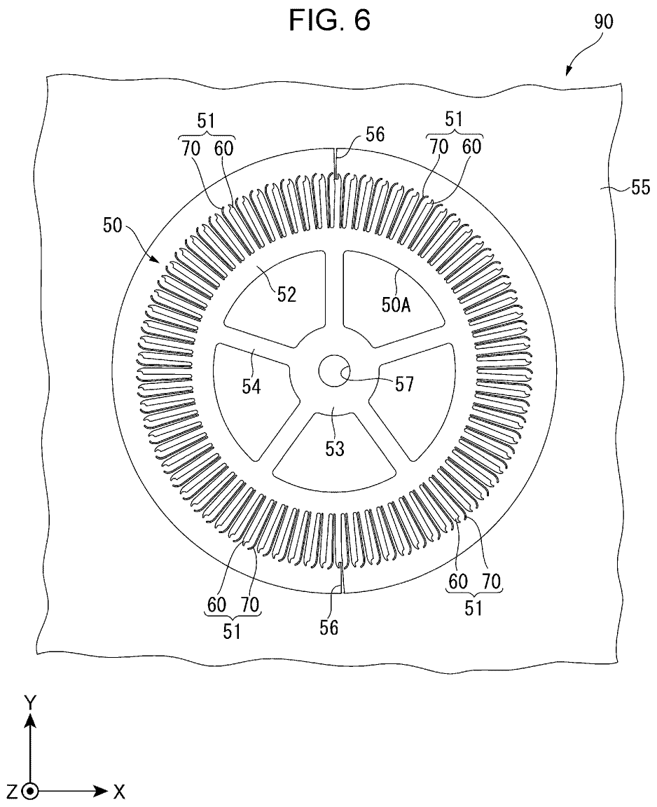

The pinion 81 that meshes with the wheel of the center wheel and pinion 25 is integrally formed in the shaft portion 80. The shaft portion 80 is inserted into a hole portion 57 (see FIG. 6) formed in a center of the wheel 50 and is fixed to the wheel 50. Therefore, the wheel 50 is rotated integrally with the pinion 81.

The wheel 50 has a plate shape and has a substantially uniform thickness over the entire surface. The wheel 50 is made of a brittle material having a crystal orientation such as single crystal silicon. The material of the wheel 50 of the present embodiment is single crystal silicon. Specifically, the wheel 50 is formed by performing etching on a silicon wafer made of single crystal silicon. A method of manufacturing the wheel 50 will be described later.

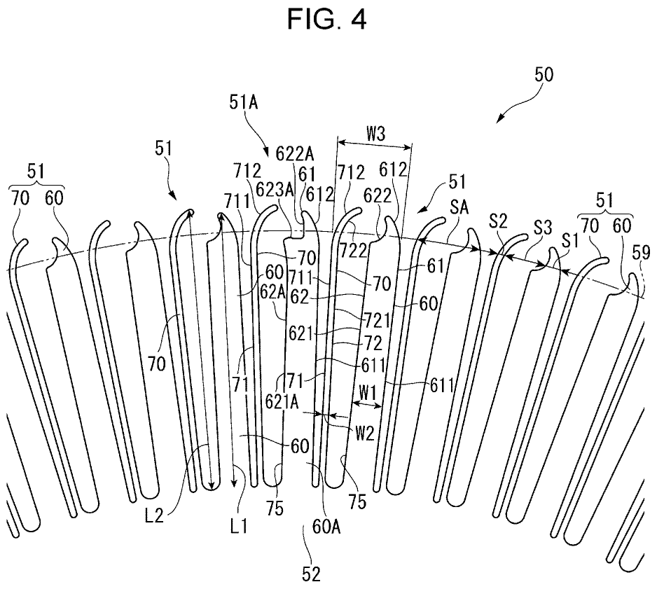

As illustrated in FIGS. 3 and 4, the wheel 50 is provided with the plurality of teeth 51 including first sub-teeth 60 and second sub-teeth 70. As will be described later, the plurality of teeth 51 includes two coupling teeth 51A each including a first sub-tooth 60A and a corresponding one of the second sub-teeth 70. The coupling teeth 51A are provided at positions between which the shaft portion 80 of the wheel 50 is interposed, that is, at intervals of approximately 180° along an outer periphery of the rim portion 52.

The first sub-teeth 60 and 60A are formed radially from the rim portion 52 and are formed at regular intervals along the outer periphery of the rim portion 52. The second sub-teeth 70 are formed radially from the rim portion 52 and are formed at regular intervals along the outer periphery of the rim portion 52. In addition, the first sub-teeth 60 and 60A, and the second sub-teeth 70 are alternately formed along the outer periphery of the rim portion 52.

Each of the plurality of teeth 51 includes a corresponding one of the first sub-teeth 60 and a corresponding one of the second sub-teeth 70 that are curved in a direction in which leading ends thereof approach each other, and each of the coupling teeth 51A includes the first sub-tooth 60A and a corresponding one of the second sub-teeth 70 that are curved in a direction in which leading ends thereof approach each other.

The first sub-tooth 60 is a drive tooth that transmits a motion to the pinion 28 of the fourth wheel and pinion 27 or the seconds wheel 29, and as illustrated in FIG. 4, includes an active tooth surface 61 and an inner surface 62.

The active tooth surface 61 is a surface that abuts on the pinion 28 or the seconds wheel 29 to transmit a motion, and includes a dedendum surface 611 and a curved surface 612. The dedendum surface 611 is a surface extending substantially linearly in a radial direction from the rim portion 52. The curved surface 612 is a surface extending from the dedendum surface 611 toward an addendum and is curved toward the second sub-tooth 70 side, and is a surface that abuts on a tooth of the pinion 28 or the seconds wheel 29 and transmits a motion.

The inner surface 62 faces the second sub-tooth 70 and defines and forms a recess 75 between the inner surface 62 and the second sub-tooth 70. The inner surface 62 includes a base end surface 621 and a leading end surface 622. The base end surface 621 extends substantially linearly from the rim portion 52 and is provided substantially parallel to the dedendum surface 611. A width W1 between the dedendum surface 611 and the base end surface 621 is substantially constant and is, for example, approximately 100 μm. The width W1 of the first sub-tooth 60 is set so that when the first sub-tooth 60 meshes with another wheel such as the pinion 28 or the seconds wheel 29, the first sub-tooth 60 serves as a rigid tooth that can transmit a motion without being elastically deformed.

The leading end surface 622 is a curved surface extending from the base end surface 621 toward the addendum and curved toward the curved surface 612. Therefore, a width between the curved surface 612 and the leading end surface 622 is formed so as to become smaller toward the addendum of the first sub-tooth 60.

The second sub-tooth 70 is a tooth that is not used for transmitting a motion and is elastically deformed to abut on a tooth of the pinion 28 or the seconds wheel 29 so as to compensate a backlash, and includes an inactive tooth surface 71 and an inner surface 72. The inactive tooth surface 71 is a surface that abuts on the pinion 28 and the seconds wheel 29 so as to compensate a backlash, and includes a dedendum surface 711 and a curved surface 712. The dedendum surface 711 is a surface extending substantially linearly in the radial direction from the rim portion 52. The curved surface 712 is a surface extending from the dedendum surface 711 toward an addendum and curved toward the first sub-tooth 60 side, and is a surface that abuts on a tooth of the pinion 28 or the seconds wheel 29 so as to compensate a backlash.

The inner surface 72 faces the first sub-tooth 60 and defines and forms the recess 75 between the inner surface 72 and the first sub-tooth 60. The inner surface 72 includes a base end surface 721 and a leading end surface 722. The base end surface 721 extends substantially linearly from the rim portion 52, and is provided substantially parallel to the dedendum surface 711. A width W2 between the dedendum surface 711 and the base end surface 721 is substantially constant, and is for example, approximately 30 μm. The leading end surface 722 is a curved surface that extends from the base end surface 721 toward the addendum and is curved similarly to the curved surface 712. The width between the curved surface 712 and the leading end surface 722 is set to be substantially equal to the width W2. The width W2 of the second sub-tooth 70 is smaller than the width W1 of the first sub-tooth 60, and is set to a width with which the second sub-tooth 70 can be elastically deformed as a whole.

As described above, each of the teeth 51 includes the first sub-tooth 60 and the second sub-tooth 70, and the recess 75 is formed between the first sub-tooth 60 and the second sub-tooth 70. The active tooth surface 61 of the first sub-tooth 60 is a first tooth surface, and the inactive tooth surface 71 of the second sub-tooth 70 is a second tooth surface opposite to the first tooth surface in the tooth 51. The recess 75 is defined by the inner surface 62 of the first sub-tooth 60, the rim portion 52, and the inner surface 72 of the second sub-tooth 70. A width W3 of the tooth 51 is a value obtained by adding the width W1 of the first sub-teeth 60, the width W2 of the second sub-teeth 70, and a width of the recess 75, and the width W3 is, for example, approximately 220 μm in a free state in which the tooth 51 does not mesh with the pinion 28 or the seconds wheel 29.

A length L1 from a dedendum, that is, the rim portion 52, to the addendum of the first sub-tooth 60 and a length L2 from a dedendum to the addendum of the second sub-tooth 70 are set to satisfy L2>L1. For example, L 2 is approximately 900 μm, and L1 is approximately 890 μm. In addition, a length from a rotation center of the wheel 50, that is, the shaft portion 80 to the outer periphery of the rim portion 52, that is, to the dedendums of the first sub-tooth 60 and the second sub-tooth 70 is set to the same length.

The coupling teeth 51A each include the first sub-tooth 60A and the second sub-tooth 70. Since the second sub-tooth 70 has the same configuration as the second sub-teeth 70 of other teeth 51, the same reference numeral is given and description thereof will be omitted. The first sub-tooth 60A includes the active tooth surface 61 and an inner surface 62A. Since the active tooth surface 61 has the same configuration as the active tooth surface 61 of the first sub-tooth 60, the same reference numeral is given and description thereof is omitted.

The inner surface 62A includes a base end surface 621A, a leading end surface 622A, and a coupling surface 623A. Similarly to the base end surface 621, the base end surface 621A extends substantially linearly from the rim portion 52 and is provided substantially parallel to the dedendum surface 611. The coupling surface 623A is formed continuously from an outer peripheral side leading end of the base end surface 621A. The coupling surface 623A is an intersecting surface that intersects with the radial direction of the wheel 50, more specifically, an orthogonal surface that is substantially orthogonal to the radial direction of the wheel 50, and extends from the base end surface 621A in a direction approaching the curved surface 612. The leading end surface 622A extends in the radial direction of the wheel 50 from an end portion of the coupling surface 623A on the curved surface 612 side toward the addendum.

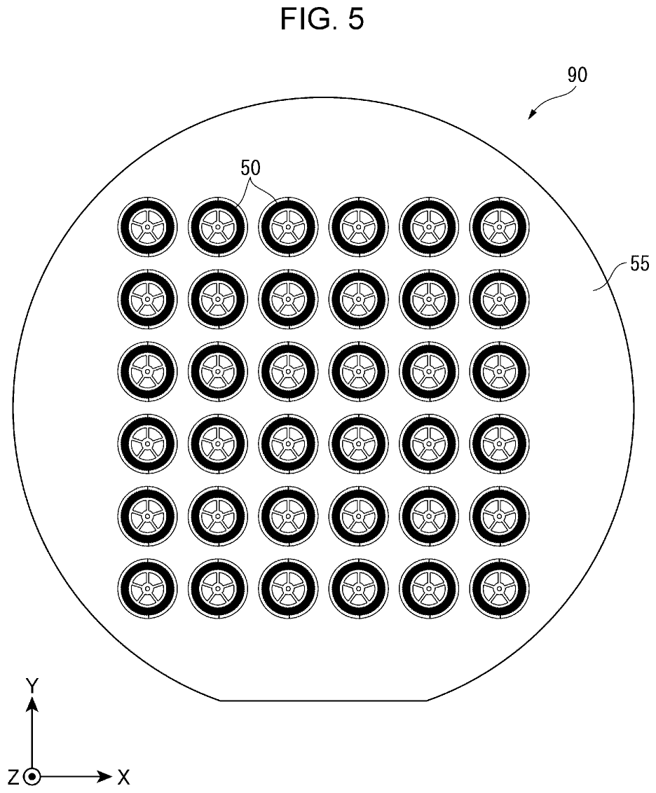

FIG. 5 is a plan view illustrating a silicon wafer 90 after being etched, and FIG. 6 is an enlarged plan view in which one wheel 50 is enlarged. In FIGS. 5 and 6, an X-axis, a Y-axis, and a Z-axis orthogonal to each other are illustrated. The X-axis is a coordinate axis parallel to a surface of the silicon wafer 90. The Y-axis is a coordinate axis parallel to the surface of the silicon wafer 90 and orthogonal to the X-axis. The Z-axis is a coordinate axis orthogonal to the surface of the silicon wafer 90, that is, an XY plane. Hereinafter, a direction parallel to the XY plane is also referred to as a plane direction, and a direction intersecting with the XY plane is also referred to as an intersecting direction.

As illustrated in FIG. 5, the silicon wafer 90 is a disk-shaped mother substrate on which a plurality of the wheels 50 can be formed. The silicon wafer 90 is an example of a plate-shaped member. In one silicon wafer 90, the plurality of wheels 50 is arranged in a matrix along the X-axis and the Y-axis. Each wheel 50 is surrounded by a frame portion 55 continuous to a peripheral edge of the silicon wafer 90. That is, the frame portion 55 is disposed outside the wheel 50.

In the present embodiment, a dimension of the silicon wafer 90 in a direction along the Z-axis, that is, a thickness of the silicon wafer 90 is approximately 100 μm to 200 μm. The thickness of the silicon wafer 90 corresponds to a tooth width of the wheel 50. In addition, a diameter of an addendum circle (not illustrated), that is, a circle passing leading ends of the teeth 51 is approximately 5 mm to 7 mm. Moreover, a tooth thickness SA of each tooth 51 is a length of an arc on a pitch circle 59 in a free state in which the tooth 51 does not mesh with the pinion 28 or the seconds wheel 29, and is the sum of a thickness S1, which is a length of an arc of the first sub-tooth 60 on the pitch circle 59, a thickness S2, which is a length of an arc of the second sub-tooth 70 on the pitch circle 59, and a width S3 of the recess 75 on the pitch circle 59. That is, SA=S1+S2+S3 is satisfied. The pitch circle 59 is a circle connecting pitch points at which the wheel 50 meshes with the pinion 28 or the seconds wheel 29. Therefore, the tooth thickness SA of the tooth 51 slightly varies depending on a center distance between the wheel 50 and the pinion 28 or the seconds wheel 29 and the tooth shape, but in the present embodiment, the tooth thickness SA is approximately 190 to 240 μm. A tooth thickness of each coupling tooth 51A is also the same dimension as the tooth thickness SA of the tooth 51. However, a tooth width, a diameter of the addendum circle, and each tooth thickness are not limited to the above-described ranges, and may be outside the above-described ranges.

The tooth thicknesses SA of the tooth 51 and the coupling tooth 51A of the wheel 50 are set to be equal to or larger than a width of a tooth groove on a pitch circle of the pinion 28 or the seconds wheel 29. Therefore, in a state in which the tooth 51 of the wheel 50 as a first wheel meshes with the pinion 28 or the seconds wheel 29 as a second wheel, the second sub-tooth 70 is elastically deformed so as to compensate a backlash.

The wheel 50 is coupled to the frame portion 55 with coupling portions 56 interposed therebetween. That is, each coupling portion 56 couples the wheel 50 to the frame portion 55, and the wheel 50 is supported by the frame portion 55 via the coupling portion 56. The coupling portions 56 are coupled to the coupling teeth 51A of the plurality of teeth 51 of the wheel 50. In the present embodiment, an angle formed by extending directions of the two coupling teeth 51A to which the coupling portions 56 are coupled is approximately 180°.

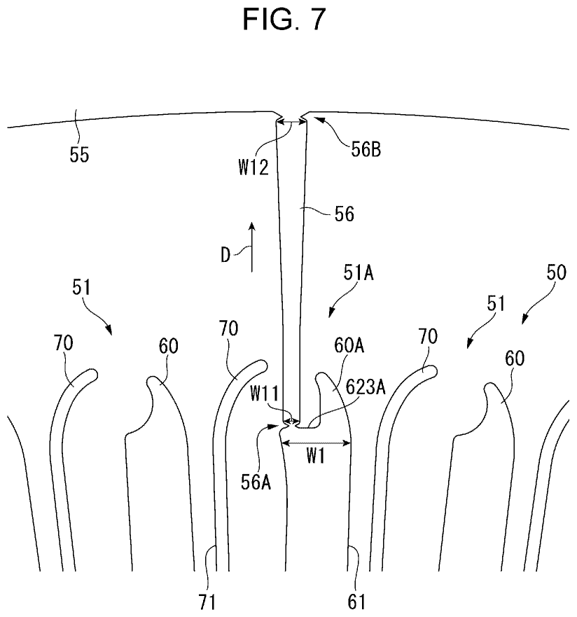

FIG. 7 is an enlarged plan view illustrating the coupling portion 56.

As a whole, the coupling portion 56 extends from the coupling surface 623A of the first sub-tooth 60A of the coupling tooth 51A in substantially the same direction as the extending direction of the coupling tooth 51A, and reaches the frame portion 55. That is, when an end portion, of both ends of the coupling portion 56, that is coupled to the coupling surface 623A of the coupling tooth 51A is a first end portion 56A and an end portion that is coupled to the frame portion 55 is a second end portion 56B, a direction D extending from the first end portion 56A to the second end portion 56B is substantially equal to the extending direction of the coupling tooth 51A.

The shape of the coupling portion 56 when viewed along the Z-axis is a linear shape. In addition, a V-shaped groove is formed at each end of the first end portion 56A and the second end portion 56B of the coupling portion 56, and a constricted portion is formed. As a result, the coupling portion 56 can be easily cut at the first end portion 56A or the second end portion 56B where the V-shaped groove is formed.

The coupling portion 56 is flexible and can be bent in a plane direction parallel to the XY plane. The first sub-tooth 60A of the coupling tooth 51A can be technically flexible, but since a width of the coupling portion 56 is substantially small compared to the width W1 of the first sub-tooth 60A, the coupling portion 56 is substantially flexible compared to the coupling teeth 51A. The width of the coupling portion 56 is preferably as small as possible in terms of improving the flexibility. On the other hand, when the width of the coupling portion 56 is too small, it is difficult to form the coupling portion 56 by etching. Therefore, the width of the coupling portion 56 is preferably 10 μm to 50 μm, and more preferably 20 μm to 40 μm. In the present embodiment, the width of the coupling portion 56 is set so as to gradually decrease from the second end portion 56B toward the first end portion 56A. For example, a width W11 of the first end portion 56A is approximately 30 μm, a width between the V-grooves processed in the first end portion 56A, that is, a width of the constricted portion is approximately 10 μm, a width W12 on the second end portion 56B side is approximately 50 μm, and a width between the V-grooves processed in the second end portion 56B is approximately 30 μm.

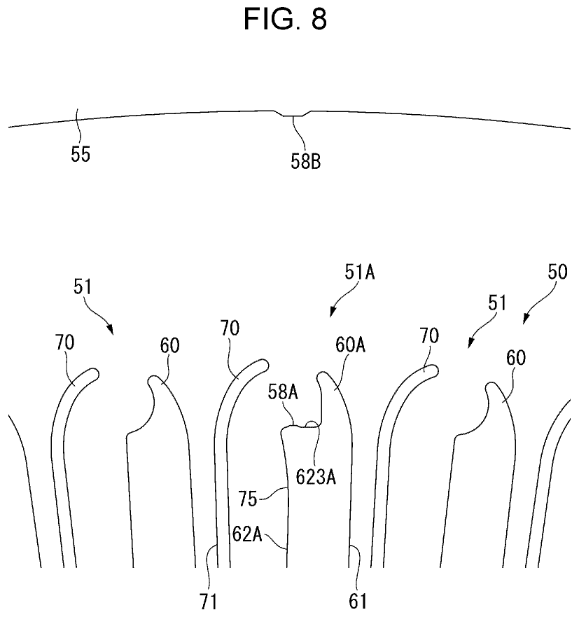

The wheel 50 in a state of being coupled to the frame portion 55 with the coupling portion 56 interposed therebetween is cut in the first end portion 56A or the second end portion 56B of the coupling portion 56 so as to be separated from the silicon wafer 90. Therefore, in the wheel 50 after being separated, as illustrated in FIG. 8, a cut surface 58A is formed on the coupling surface 623A of the coupling tooth 51A that has been coupled to the coupling portion 56. That is, the cut surface 58A is a surface that has been coupled to the first end portion 56A of the coupling portion 56. The cut surface 58A is formed in the recess 75 of the coupling tooth 51A, and is not formed on the active tooth surface 61 or the inactive tooth surface 71. Therefore, even if a projection or the like is left on the cut surface 58A, the cut surface 58A does not come into contact with the pinion 28 or the seconds wheel 29 that is a meshing target of the coupling tooth 51A, and does not affect the operation of the wheel 50. A cut surface 58B is formed in a portion where the second end portion 56B of the coupling portion 56 is cut from the frame portion 55.

The single crystal silicon, which is the material of the wheel 50, includes a plurality of crystal planes and has a property of being easily cleaved along a crystal plane. That is, single crystal silicon can be cut with a small force when being cut along a crystal plane, compared to a case of being cut along a plane other than a crystal plane. In addition, when single crystal silicon is cut along a crystal plane, spreading of a crack, generated by cutting, in a direction other than the direction of the crystal plane is prevented or reduced. Therefore, both front and back surfaces of the wheel 50 parallel to the XY plane, and the cut surface 58A and the cut surface 58B that have been coupled to the coupling portion 56 are preferably crystal planes.

Next, a method of manufacturing the wheel 50 included in the third wheel and pinion 26 will be described.

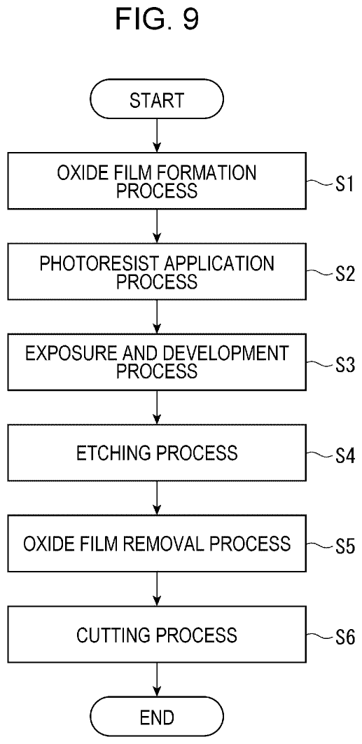

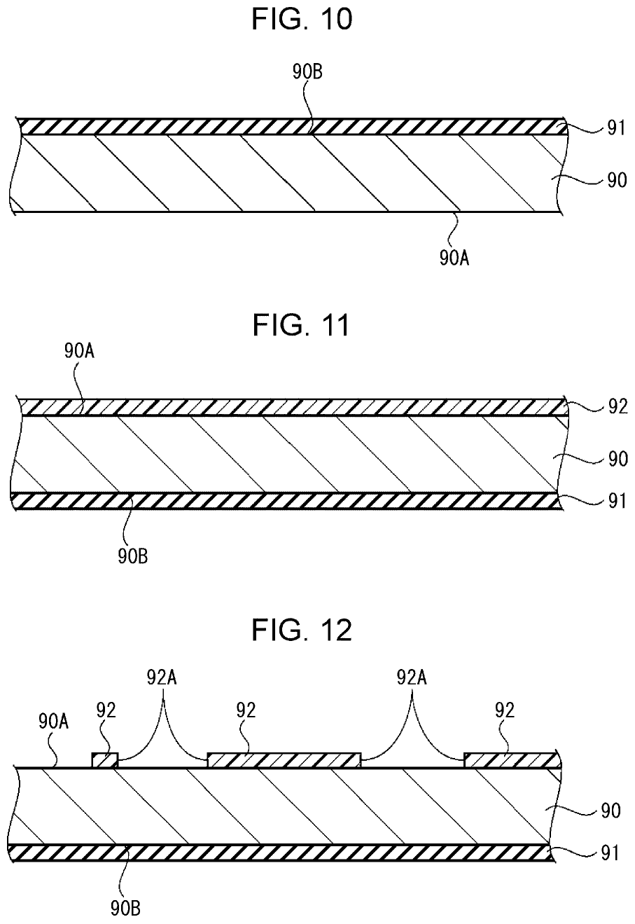

FIG. 9 is a flowchart illustrating the method of manufacturing the wheel 50, and FIGS. 10 to 18 are process sectional views for explaining the method of manufacturing the wheel 50.

As illustrated in FIG. 9, the method of manufacturing the wheel 50 includes each process of steps S1 to S6. That is, the wheel 50 is manufactured by performing each process of steps S1 to S6 in sequence.

Step S1 is an oxide film formation process. As illustrated in FIG. 10, in this process, a silicon oxide film 91 is formed on one plane of the silicon wafer 90. The silicon wafer 90 is ground in advance to have an appropriate thickness so that the tooth width of the wheel 50 has a desired dimension, and a surface of the silicon wafer 90 is polished.

The silicon wafer 90 has two planes, which are a first surface 90A and a second surface 90B on the front and rear sides. In step S1, the silicon oxide film 91 is formed on the second surface 90B. For formation of the silicon oxide film 91, a chemical vapor deposition (CVD) method is used. A film thickness of the silicon oxide film 91 is not particularly limited, but is, for example, approximately 1 μm. The silicon oxide film 91 is formed in order to prevent or reduce extending of holes 90C, which are formed in an etching process of step S4 described later, through the front and rear sides.

Step S2 is a photoresist application process. As illustrated in FIG. 11, in this process, a resist film 92 is formed on the first surface 90A of the silicon wafer 90. First, a resin solution, in which a photosensitive resin is dissolved, is applied to the first surface 90A of the silicon wafer 90 by a spin coating method, a spray coating method, or the like. Next, the resin solution is dried to remove a solvent so as to form the resist film 92. For the photosensitive resin, either a negative material or a positive material may be adopted.

Step S3 is an exposure and development process. In this process, an etching mask for forming the wheel 50 is formed. First, using a photomask, in which a pattern corresponding to the plurality of wheels 50, the frame portion 55, and a plurality of the coupling portions 56 coupling the plurality of wheels 50 to the frame portions 55, as illustrated in FIG. 5, is formed, exposure is performed on the resist film 92. Then, after development is performed to remove unnecessary portions of the resist film 92, in the resist film 92, as illustrated in FIG. 12, opening portions 92A corresponding to the pattern of the photomask are formed. The opening portions 92A correspond to portions of silicon to be removed from the silicon wafer 90 by etching. That is, the resist film 92, in which the opening portions 92A are formed, functions as an etching mask.

Step S4 is an etching process. In this process, by performing etching on the silicon wafer 90 using the resist film 92 as an etching mask, shapes of the wheels 50, the frame portion 55, and the coupling portions 56 are formed. For etching, for example, anisotropic etching such as deep reactive ion etching (DRIE) by inductively coupled plasma (ICP), or the like is used. Since a known apparatus in the related art can be used as an anisotropic etching apparatus for performing DRIE by ICP, a description thereof will be omitted.

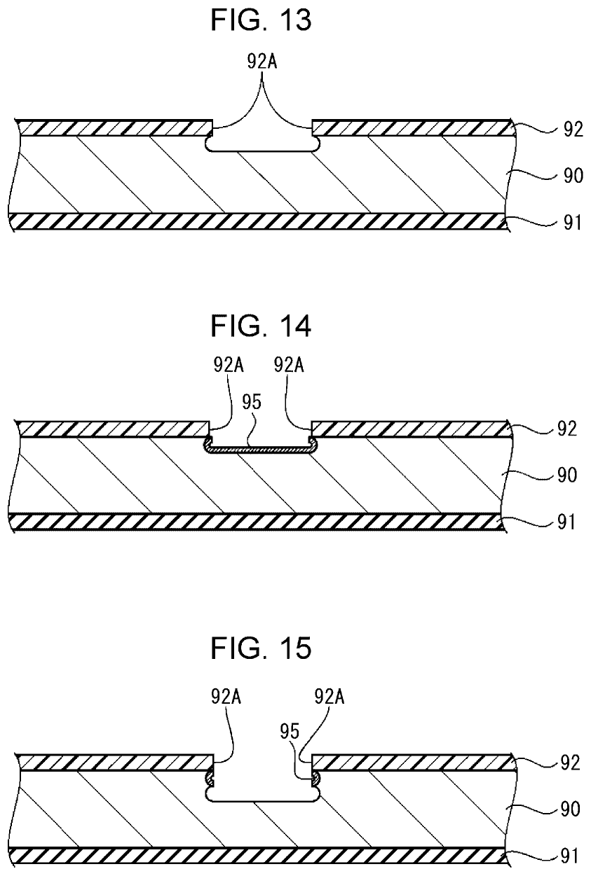

As illustrated in FIG. 13, when the silicon wafer 90 is scraped to have a predetermined depth by anisotropic etching, the anisotropic etching apparatus supplies a C₄F₈ gas to a surface of the silicon wafer 90 so as to form a protective film 95 on a surface to which silicon is exposed, as illustrated in FIG. 14. Forming the protective film 95 is also referred to as coating.

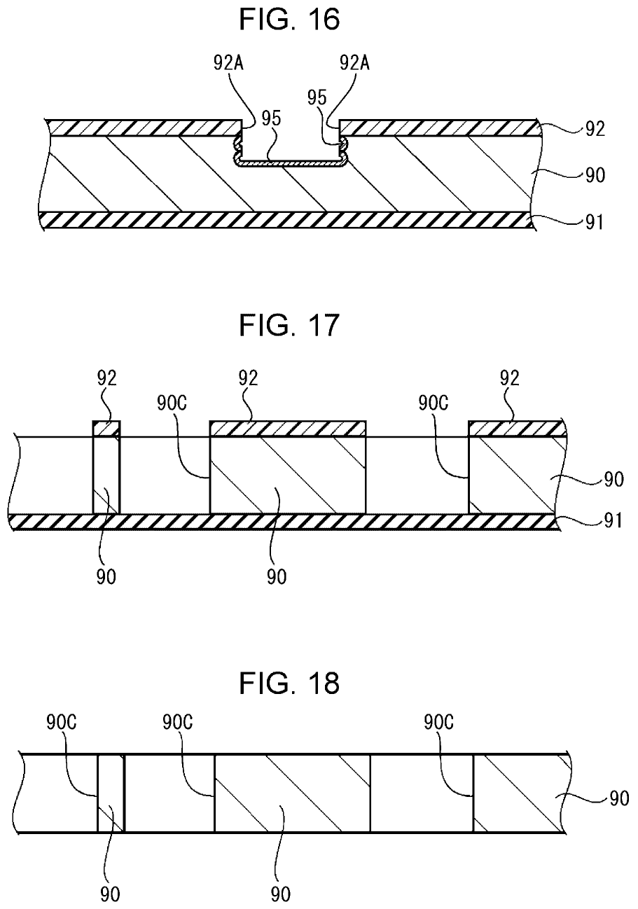

Then, as illustrated in FIG. 15, the anisotropic etching apparatus performs etching on the silicon wafer 90 again so as to expose silicon and subsequently, as illustrated in FIG. 16, performs coating with the protective film 95 again. In this manner, the anisotropic etching apparatus repeatedly performs etching on the silicon wafer 90 and coating with the protective film 95 a plurality of times. This method is called a Bosch process. By the Bosch process, as illustrated in FIG. 17, in the silicon wafer 90, the holes 90C that reach the silicon oxide film 91 are formed in portions not covered with the resist film 92. Here, the holes 90C include a gap between the wheel 50 and the frame portion 55, and the opening portion 50A and the hole portion 57 formed in the wheel 50.

Step S5 is an oxide film removal process. In this process, as illustrated in FIG. 18, the silicon oxide film 91 and the resist film 92 disposed on the silicon wafer 90 are removed. Removal of the resist film 92 can be performed by wet etching with fuming nitric acid, an organic solvent, or the like capable of dissolving and stripping the resist film 92, oxygen plasma ashing, or the like. In the present embodiment, after oxygen plasma ashing is performed, an organic stripping agent is further used to remove a residual.

Removal of the silicon oxide film 91 is performed by wet etching in which the silicon wafer 90 is immersed in a buffered hydrogen fluoride (BHF) solution. Removal of the silicon oxide film 91 may be performed by reactive ion etching using a parallel plate.

As described above, by steps S1 to S5, the plurality of wheels 50, the frame portion 55, and the plurality of coupling portions 56 that couples the wheels 50 to the frame portion 55 illustrated in in FIG. 5 are formed. That is, a series of processes including steps S1 to S5 is a first step of forming the wheels 50, the frame portion 55, and the coupling portions 56 by performing etching on the silicon wafer 90.

Step S6 is a cutting process. This process is a second step of cutting the coupling portions 56 and the wheels 50. The operation of cutting the coupling portions 56 and the wheels 50 is performed using a tool having a fine tip such as tweezers. Specifically, an operator mounts the silicon wafer 90 illustrated in FIGS. 5 and 6 on a worktable (not illustrated) and fixes the frame portion 55 to the worktable. Then, the operator inserts the tool into the opening portion 50A inside each wheel 50, and displaces the wheel 50 in the plane direction while keeping the tool in contact with the opening portion 50A. That is, the wheel 50 is displaced in the plane direction with respect to the frame portion 55 by the tool. At this time, the first end portion 56A of each coupling portion 56 is also displaced following the displacement of the wheel 50, but since the coupling portion 56 is bent due to the flexibility, the coupling portion 56 does not break in the middle thereof. In addition, when a force acting on the first end portion 56A reaches a predetermined value, the first end portion 56A breaks, and the coupling portion 56 and the wheel 50 are cut. When the second end portion 56B is cut, the first end portion 56A may be cut by gripping the coupling portion 56 with the tool.

By step S6, the wheel 50 is separated from the silicon wafer 90, as a result of which the wheel 50 is completed. That is, the wheel 50 is generated by being cut from the silicon wafer 90. In addition, the cut surface 58A is formed on the coupling surface 623A of the first sub-tooth 60A, which is an inner surface of the recess 75 of the coupling tooth 51A, to which the coupling portion 56 is coupled when the wheel 50 is cut from the silicon wafer 90. Therefore, the plurality of teeth 51 included in the wheel 50 includes two coupling teeth 51A each including the cut surface 58A on the inner surface of the recess 75.

The two coupling portions 56 may be cut one by one in sequence, but the two coupling portions 56 may be cut in a single operation. For example, when a shaft is inserted into the hole portion 57 at the center of the wheel 50 so that the wheel 50 is turned around the shaft, the two coupling portions 56 can be easily cut by a single operation. In addition, a direction in which the wheel 50 is displaced is not limited to the plane direction, and the coupling portions 56 may be cut by displacing the wheel 50 in an intersecting direction.

Next, a method of manufacturing the mechanical timepiece 1 will be described.

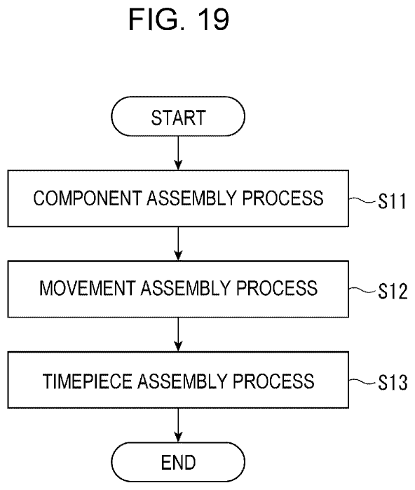

FIG. 19 is a flowchart illustrating the method of manufacturing the mechanical timepiece 1.

As illustrated in FIG. 19, the method of manufacturing the mechanical timepiece 1 includes each process of steps S11 to S13. That is, the mechanical timepiece 1 is manufactured by performing each process of steps S11 to S13 in sequence.

Step S11 is a component assembly process in which various components constituting the mechanical timepiece 1 are assembled. For example, the third wheel and pinion 26, which is one component, is assembled by inserting the shaft portion 80 into the hole portion 57 of the wheel 50 formed by the above-described steps S1 to S6. Components other than the third wheel and pinion 26 are also assembled where necessary.

Step S12 is a movement assembly process in which the movement 10 is assembled. This process includes a process in which various components such as the third wheel and pinion 26 are assembled in the main plate 11.

Step S13 is a timepiece assembly process in which the mechanical timepiece 1 is assembled. This process includes a process in which the movement 10 is accommodated in the casing 2. By the above-described processes, the mechanical timepiece 1 is completed.

As described above, according to the wheel 50 and the method of manufacturing the wheel 50 of the present embodiment, the following effects can be obtained.

According to the present embodiment, since the coupling portion 56 is coupled to the inner surface of the recess 75 of the coupling tooth 51A, specifically, to the coupling surface 623A of the first sub-tooth 60A, and the cut surface 58A after the coupling portion 56 is cut is not provided on the active tooth surface 61 of the first sub-tooth 60A or the inactive tooth surface 71 of the second sub-tooth 70, the cut surface 58A can be prevented from coming into contact with the pinion 28 or the seconds wheel 29. Therefore, the cut surface 58A of the coupling tooth 51A can be prevented from affecting meshing with the pinion 28 or the seconds wheel 29.

Since the coupling portion 56 is coupled to the first sub-tooth 60A having the width W1 larger than the width W2 of the second sub-tooth 70, the first sub-tooth 60A can be prevented from being damaged even if a stress is applied when the coupling portion 56 is cut. Therefore, the second step of cutting the coupling portion 56 can be easily performed.

In addition, since the coupling surface 623A to which the coupling portion 56 is coupled is a surface intersecting with the radial direction of the wheel 50, that is, the extending direction of the first sub-tooth 60A in a substantially orthogonal direction, the coupling portion 56 can be easily cut by displacing the wheel 50 in the plane direction. Therefore, the wheel 50 can be easily taken out from the frame portion 55 of the silicon wafer 90.

Moreover, since the silicon wafer 90 is made of single crystal silicon, which is a brittle material, and the coupling surface 623A is provided along a crystal plane of the single crystal silicon, the coupling portion 56 and the coupling surface 623A can be cut with a small force, and it is possible to prevent or reduce spreading of a crack, caused by the cutting, in a direction other than a direction along the crystal plane, that is, the coupling surface 623A. Therefore, the cut surface 58A can be formed into a flat plane along the coupling surface 623A.

According to the present embodiment, a constricted portion is formed in the first end portion 56A of the coupling portion 56. That is, since the first end portion 56A is thinner than other portions of the coupling portion 56, the coupling portion 56 and the wheel 50 can be easily cut in the first end portion 56A.

In addition, according to the present embodiment, when the wheel 50 is displaced in the cutting process of step S6, the tool is brought into contact with the opening portion 50A without being brought into contact with the tooth 51. In this manner, since the tool is brought into contact with a portion other than the tooth 51 at the time of cutting, damaging the tooth 51 by the tool can be prevented or reduced.

In addition, according to the silicon wafer 90 in a state in which the wheel 50, the frame portion 55, and the coupling portion 56 are formed through the first step of the present embodiment, the wheel 50 having the above-described effects can be easily formed.

Each tooth 51 and each coupling tooth 51A of the wheel 50 have the first sub-tooth 60 or the first sub-tooth 60A and the second sub-tooth 70, and the second sub-tooth 70 has the width W2 that is small and is elastically deformable. Therefore, when the active tooth surfaces 61 of the first sub-teeth 60 and 60A of the wheel 50 as the third wheel and pinion 26 abut on an active tooth surface of the pinion 28 or the seconds wheel 29 to transmit a motion, the inactive tooth surface 71 of the second sub-tooth 70 abuts on an inactive tooth surface of the pinion 28 or the seconds wheel 29 so as to be able to reduce a backlash.

According to the mechanical timepiece 1 of the present embodiment, since the wheel 50 having the above-described effects is used, a stable operation can be realized.

The above-described embodiment may be modified as follows.

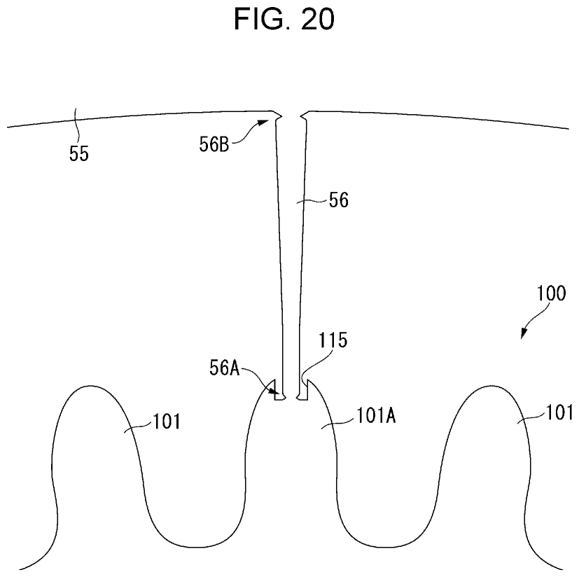

In the above-described embodiment, each tooth 51 of the wheel 50 includes the first sub-tooth 60 and the second sub-tooth 70, and each coupling tooth 51A includes the first sub-tooth 60A and the second sub-tooth 70. However, the structures of the tooth and the coupling tooth are not limited thereto. For example, as illustrated in FIG. 20, a wheel 100 formed of a general spur gear including a plurality of teeth 101 may be used. The wheel 100 has a coupling tooth 101A coupled to the coupling portion 56. The coupling tooth 101A has a recess 115 opened toward an addendum side, and the coupling portion 56 is coupled to the recess 115. In the wheel 100 as well, when the first end portion 56A of the coupling portion 56 is cut from the wheel 100, the cut surface is formed within the recess 115, so that the cut surface does not affect meshing between the wheel 100 and other wheels.

In addition, the shape of the coupling portion 56 is not limited to a linear shape, and may be a wavy line shape or the like. The shape of the coupling portion 56 is not particularly limited as long as the coupling portion 56 can follow the displacement of the wheel 50 in the plane direction to some extent by the flexibility.

In the above-described embodiment, two coupling portions 56 are coupled to each wheel 50 and each wheel 100, and an angle formed by the extending directions of the two coupling teeth 51A or two coupling teeth 101A to which the coupling portions 56 are coupled is substantially 180°, but is not limited thereto. For example, the angle formed by the extending directions of the two coupling teeth 51A or the two coupling teeth 101A to which the coupling portions 56 are coupled may be substantially 90°, or may be another angle. The number of the coupling portions 56 is not limited to two, and may be one, or three or more. Alternatively, in a configuration in which the plurality of the coupling portions 56 is coupled to one wheel 50 or 100, the shapes and dimensions of the plurality of coupling portions 56 may be the same or different.

In the above-described embodiment, the direction D extending from the first end portion 56A toward the second end portion 56B of each coupling portion 56 is substantially the same as the extending direction of the coupling tooth 51A to which the coupling portion 56 is coupled, but the direction D may be a direction different from the extending direction of the coupling tooth 51A.

The coupling surface 623A to which the first end portion 56A of the coupling portion 56 is coupled is not limited to a surface orthogonal to the extending direction of the first sub-tooth 60A or the coupling tooth 101A, and may be a surface extending along the extending direction, for example, the leading end surface 622A. That is, since the crystal plane of the single crystal silicon is formed in two orthogonal directions, both the coupling surface 623A and the leading end surface 622A are surfaces along the crystal plane, and the first end portion 56A can be easily cut.

In the above-described embodiment, when the holes 90C are formed by a Bosch process in the etching process of step S4, irregularities called scallops are formed on an etched surface. A process of removing the scallops may be additionally performed. In this process, for example, after an oxide film having a depth of 1 μm or more is formed in the silicon wafer 90 by thermal oxidation, the silicon wafer 90 may be immersed in a BHF solution so as to perform etching on the oxide film.

In the above-described embodiment, in the component assembly process of step S11, after the shaft portion 80 is inserted into the wheel 50, an oxidation treatment, in which a silicon oxide film made of silicon dioxide (SiO₂) is formed on a surface of the wheel 50, may be performed. When the oxidation treatment is performed on the wheel 50, mechanical strength of the wheel 50 is improved by a silicon oxide film formed on the surface of the wheel 50 made of a material containing silicon. When the oxidation treatment is performed, for example, a thermal oxidation treatment that is performed at a high temperature of 1000° C. or higher is preferably performed.

In the above-described embodiment, as the material of the wheel 50, silicon is used as a plate-shaped member made of a brittle material, but the material of the wheel 50 is not limited to silicon. For example, silicon carbide, quartz crystal, glass, sapphire, or the like may be used.

In the above-described embodiment, the wheel 50 of the third wheel and pinion 26 constituting the front train wheel of the mechanical timepiece 1 is exemplified, but the structure of the wheel 50 and the method of manufacturing the wheel 50 illustrated in the above-described embodiment are applicable to various wheels such as other wheels constituting the front train wheel and wheels constituting the rear train wheel. In addition, the timepiece is not limited to the mechanical timepiece 1, and may be other timepieces such as an electronic timepiece. That is, the structure of the wheel 50 and the method of manufacturing the wheel 50 described in the above-described embodiment are applicable to wheels included in an electronic timepiece, or the like.

### Summary of Present Disclosure

According to the present disclosure, there is provided a method of manufacturing a wheel including a first step of performing etching on a plate-shaped member made of a brittle material to form a wheel including a plurality of teeth including a coupling tooth having a recess opened radially outward at a leading end, a frame portion disposed outside the wheel, and a coupling portion coupling the frame portion to an inner surface of the recess, and a second step of cutting the coupling portion and the wheel.

According to the present disclosure, the wheel can be manufactured by, in the first step, performing etching on the plate-shaped member made of a brittle material such as single crystal silicon to process and form the wheel and the frame portion coupled by the coupling portion, and by, in the second step, cutting the coupling portion and the wheel. In addition, in the wheel, since the coupling tooth to which the coupling portion is coupled has a recess opened radially outward at the leading end and the coupling portion is coupled to the inner surface of the recess, the cut surface obtained by cutting the coupling portion is formed on the inner surface of the recess and is not exposed to an active tooth surface or an inactive tooth surface of each of the teeth, a motion can be appropriately transmitted between the wheel of the present disclosure and a mating wheel that meshes with the wheel.

In the method of manufacturing a wheel according to the present disclosure, the first step includes forming, as the coupling tooth, a first sub-tooth including a first tooth surface, a second sub-tooth including a second tooth surface opposite to the first tooth surface, and the recess provided between the first sub-tooth and the second sub-tooth, the first sub-tooth has a tooth thickness larger than a tooth thickness of the second sub-tooth, and the recess has an inner surface to which the coupling portion is coupled and that is a surface of the first sub-tooth.

According to the present disclosure, the coupling tooth includes the first sub-tooth and the second sub-tooth, and the first sub-tooth has a tooth thickness larger than the tooth thickness of the second sub-tooth. Therefore, the first tooth surface, that is, an active tooth surface of the first sub-tooth can abut on an active tooth surface of the mating wheel to appropriately transmit a motion. In addition, since the tooth thickness of the second sub-tooth is thinner than that of the first sub-tooth, when the first tooth surface of the first sub-tooth abuts on the active tooth surface of the mating wheel to transmit a motion, the second sub-tooth can abut on an inactive tooth surface of the mating wheel while being elastically deformed, so as to be able to reduce and compensate a backlash.

In addition, since the inner surface of the recess to which the coupling portion is coupled is constituted by a surface of the first sub-tooth having a large tooth thickness, the first sub-tooth can be prevented from being damaged when the coupling portion is deformed and cut from the inner surface of the recess.

In the method of manufacturing a wheel according to the present disclosure, the first step includes forming an intersecting surface intersecting with a radial direction of the wheel as the inner surface of the recess, and the coupling portion is coupled to the intersecting surface.

According to the present disclosure, since the inner surface of the recess is an intersecting surface intersecting with the radial direction of the wheel, the coupling portion can be easily cut from the inner surface of the recess.

In the method for manufacturing a wheel according to the present disclosure, it is preferable that the brittle material is single crystal silicon, and in the second step, the coupling portion is cut along a crystal plane of the single crystal silicon.

According to the present disclosure, since the coupling portion is cut along the crystal plane of the single crystal silicon, the coupling portion can be cut with a small force, and spreading of a crack, caused by the cutting, in a direction other than the crystal plane can be reduced.

According to the present disclosure, there is provided a plate-shaped member made of a brittle material, the plate-shaped member including a wheel including a plurality of teeth including a coupling tooth having a recess opened radially outward at a leading end, a frame portion disposed outside the wheel, and a coupling portion coupling the frame portion to an inner surface of the recess.

According to the plate-shaped member of the present disclosure, since the coupling tooth to which the coupling portion is coupled has the recess opened radially outward at the leading end, and the coupling portion is coupled to the inner surface of the recess, a cut surface obtained by cutting the coupling portion is formed on the inner surface of the recess and is not exposed to an active tooth surface or an inactive tooth surface of each of the teeth. Therefore, the wheel taken out by cutting the cut portion can appropriately transmit a motion to a mating wheel with which the wheel meshes.

According to the present disclosure, there is provided a wheel generated by being cut from a plate-shaped member made of a brittle material, the wheel including a plurality of teeth, in which the plurality of teeth includes at least one tooth that is a coupling tooth having a recess opened radially outward at a leading end and having a cut surface formed when being cut from the plate-shaped member.

According to the wheel of the present disclosure, the coupling tooth to which the coupling portion is coupled includes the recess opened radially outward at the leading end, and the coupling portion is coupled to the inner surface of the recess. Therefore, the cut surface obtained by cutting the coupling portion is formed on the inner surface of the recess, and is not exposed to an active tooth surface or an inactive tooth surface of the tooth. Therefore, the wheel taken out by cutting the cut portion can appropriately transmit a motion to a mating wheel with which the wheel meshes.

In the wheel according to the present disclosure, the coupling tooth includes a first sub-tooth including a first tooth surface, a second sub-tooth including a second tooth surface opposite to the first tooth surface, and the recess provided between the first sub-tooth and the second sub-tooth, the first sub-tooth has a tooth thickness larger than a tooth thickness of the second sub-tooth, and the recess has an inner surface to which a coupling portion is coupled and that is a surface of the first sub-tooth.

According to the wheel of the present disclosure, the coupling tooth includes the first sub-tooth and the second sub-tooth, and the first sub-tooth has a tooth thickness larger than the tooth thickness of the second sub-tooth. Therefore, the first tooth surface, that is, an active tooth surface of the first sub-tooth can abut on an active tooth surface of a mating wheel to appropriately transmit a motion. In addition, since the tooth thickness of the second sub-tooth is thinner than that of the first sub-tooth, when the first tooth surface of the first sub-tooth abuts on the active tooth surface of the mating wheel to transmit a motion, the second sub-tooth can abut on an inactive tooth surface of the mating wheel while being elastically deformed, so as to be able to reduce and compensate a backlash.

In addition, since the inner surface of the recess to which the coupling portion is coupled is constituted by a surface of the first sub-tooth having a large tooth thickness, the first sub-tooth can be prevented from being damaged when the coupling portion is deformed and cut from the inner surface of the recess.

According to the present disclosure, there is provided a timepiece including the wheel.

According to the timepiece of the present disclosure, since the timepiece includes the wheel, a motion can be appropriately transmitted between the wheel and a mating wheel that meshes with the wheel.

1. A method of manufacturing a wheel comprising:
a first step of performing etching on a plate-shaped member made of a brittle material to form a wheel including a plurality of teeth including a coupling tooth having a recess opened radially outward at a leading end, a frame portion disposed outside the wheel, and a coupling portion coupling the frame portion to an inner surface of the recess; and
a second step of cutting the coupling portion and the wheel.

2. The method of manufacturing a wheel according to claim 1, wherein
the first step includes forming, as the coupling tooth, a first sub-tooth including a first tooth surface, a second sub-tooth including a second tooth surface opposite to the first tooth surface, and the recess provided between the first sub-tooth and the second sub-tooth,
the first sub-tooth has a tooth thickness larger than a tooth thickness of the second sub-tooth, and
the recess has an inner surface to which the coupling portion is coupled and that is a surface of the first sub-tooth.

3. The method of manufacturing a wheel according to claim 1, wherein
the first step includes forming an intersecting surface intersecting with a radial direction of the wheel as the inner surface of the recess, and
the coupling portion is coupled to the intersecting surface.

4. The method of manufacturing a wheel according to claim 1, wherein
the brittle material is single crystal silicon, and
in the second step, the coupling portion is cut along a crystal plane of the single crystal silicon.

5. A plate-shaped member made of a brittle material, the plate-shaped member comprising:
a wheel including a plurality of teeth including a coupling tooth having a recess opened radially outward at a leading end,
a frame portion disposed outside the wheel, and
a coupling portion coupling the frame portion to an inner surface of the recess.

6. A wheel generated by being cut from a plate-shaped member made of a brittle material, the wheel comprising:
a plurality of teeth, wherein
the plurality of teeth includes at least one tooth that is a coupling tooth having a recess opened radially outward at a leading end and having a cut surface formed when being cut from the plate-shaped member.

7. The wheel according to claim 6, wherein
the coupling tooth includes a first sub-tooth including a first tooth surface, a second sub-tooth including a second tooth surface opposite to the first tooth surface, and the recess provided between the first sub-tooth and the second sub-tooth,
the first sub-tooth has a tooth thickness larger than a tooth thickness of the second sub-tooth, and
the recess has an inner surface to which a coupling portion is coupled and that is a surface of the first sub-tooth.

8. A timepiece comprising the wheel according to claim 6.
